(19) United States
(12) Patent Application Publication
(10) Pub. No.: US 2006/0006628 A1
(43) Pub. Date: Jan. 12, 2006

(54) Mobile tool station and work table

(76) Inventor: Walter Samuel Fields, Victorville, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/179,195

(22) Filed: Jul. 11, 2005

Related U.S. Application Data
(60) Provisional application No. 60/587,239, filed on Jul. 12, 2004.

(51) Int. Cl. B62B 1/00

(52) U.S. Cl. 280/640

(57) ABSTRACT

A mobile tool station and worktable is disclosed. The mobile worktable is supported on wheels that can be locked to prevent movement, or unlocked to allow free movement of the workbench. The worktable allows a person to assemble, test or build items on top of the table. The table also includes a tool station for the person to locate tools or a tool case that can be removed from the worktable. The tool station is configured on a gurney type configuration where an additional set of wheels can be located at one or both ends of the table to allow the additional set of wheels to be placed in the bed of a truck and the work table collapsed to allow a single person to place or remove the table in the back of a truck.

### CROSS REFERENCE TO RELATED APPLICATION

This application claims priority to applicant's provisional patent application Ser. No. 60/587,239 filed Jul. 12, 2004.

### DESCRIPTION

### FIELD OF THE INVENTION

This invention relates to a mobile tool station and worktable. More particularly, the present invention relates to a worktable that is supported on wheels that can be locked from moving or can be unlocked for movement of the workbench. The worktable allows a person to assemble, work, test or build items on top of the table. The table also includes a tool station for the person to locate tools or a tool case that can be removed from the worktable. An additional set of wheels can be located at one or both ends of the table to allow the wheels to be placed in or on the bed of a truck and the work table collapsed to allow a single person to place the table in the back of the truck.

### BACKGROUND OF THE INVENTION

Today working people need to set-up and work in a variety of places. Often the work is performed in the field or in places where a workman needs to set-up quickly and begin to work. This requires them to bring a variety of tools with them. They may also need to erect a workbench where none is available. The working location may be in the middle of a field or inside a house that is being constructed. The worker needs to easily transport their tools from the vehicle or truck to where the work is to be performed. Several patents have been issued that provide transportation of work benches or tool chest, but none of them are collapsible to be easily stored and removed from a truck by one person.

U.S. Pat. No. 3,734,151 issued May 22, 1973 to Skripsky discloses a portable workbench. The portable workbench is collapsible and allows the tool bench to be taken apart and broken down for transportation. The portable workbench has openings in the top to allow different tools or workstations to be placed in the top of the workbench. While the portable workbench is collapsible for easier transportation, the workbench does not have wheels for transporting nor does it collapse onto a supplemental set of wheels for easy one-person storage within a truck or vehicle. The portable workstation further does not allow for temporary storage of a toolbox.

U.S. Pat. No. 4,265,283 issued May 5, 1981 to Nash et al discloses a workbench structure. The workbench structure consists of a workbench with wheels located on one side of the workbench structure. The workbench is not collapsible and does not have a support means for storing a toolbox. The workbench structure does not collapse for placement within a truck or vehicle by a single person.

U.S. Pat. No. 4,875,513 issued Oct. 24, 1989 to Skarsten discloses a portable workbench. The workbench consists of pieces that are placed together to create a workbench. The workbench is collapsible by folding the workbench and carrying the workbench. The workbench is portable but does not include wheels for transporting. The workbench also does not allow for storage for a toolbox.

U.S. Pat. No. 6,523,583 issued Feb. 25, 2003 to Ruiz discloses a workbench with an extendable footstep assembly. The workbench includes four wheels for easy movement of the workbench. The wheels also include brakes to locking the workbench to prevent movement. This tool bench is not collapsible for easier placement in a truck. This patent has storage for tools, but does not have storage for a removable toolbox.

What is needed it is a mobile tool transporter and workbench that can be configured on a gurney type transporter that can be collapsed for storage within a truck. The ideal device would provide for the tool box to be removable from the gurney, the height of the work bench to be adjustable, an additional set of wheels located under the workbench for placement in the bed of a truck and the gurney collapsed so the mobile tool transporter can be slid into the truck by a single person. The proposed device satisfies these needs with a simple to use mobile tool transporter and workbench.

### BRIEF SUMMARY OF THE INVENTION

The present invention relates to a mobile tool station and worktable. Currently there is no single product that provides all the features and function described and disclosed by this application. The features disclosed make it easy for a workman to transport his tools and allows them to easily set-up and begin working as well as break down the workbench and transport the workbench to another location or job site.

One object of the mobile tool station is to provide a tool station that can be easily erected by a single person.

Another object of the mobile tool station is to allow a storage location for a tool bench.

Another object of the mobile tool station is to provide a tool station with wheels for easier transportation.

Another object of the mobile tool station is to provide a collapsible work bench configured on a gurney type base where the mobile workbench can be collapsed onto the bed of a vehicle or truck and rolled into the back of the truck by a single person.

Another object of the mobile tool station allows for the height of the mobile tool station to adjustable to allow the operator to raise or lower the height of the workbench to accommodate the comfort of the operator.

Still another object of the mobile tool station is providing a braking mechanism on one or more wheels to prevent the mobile tool station from moving unexpectedly.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric view of one embodiment of the mobile workbench on a collapsible gurney.

FIG. 2 is an isometric view of the collapsible gurney from FIG. 1 being loaded into the bed of a truck.

FIG. 3 is an isometric view of one embodiment of the mobile workbench configured for painting with a height adjustable gurney.

FIG. 4 is an isometric view of the mobile workbench from FIG. 3 shown in a collapsible configuration.

FIG. 5 is an isometric view of one embodiment of the mobile workbench shown with a removable toolbox.

FIG. 6 is an isometric view of one embodiment of the mobile workbench from FIG. 5 shown with the toolbox removed.

FIG. 7 is an isometric view of one embodiment of the mobile workbench shown with the work-top removed showing the internal compartments.

### DETAILED DESCRIPTION

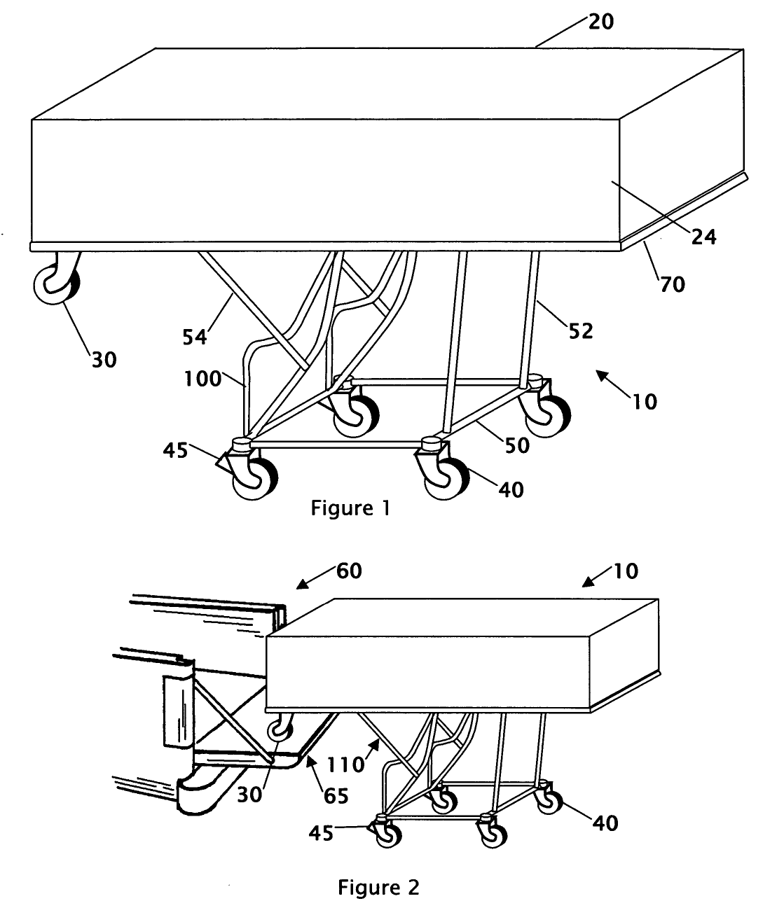

Referring to FIG. 1, there is shown an isometric view of one embodiment of the mobile workbench 10 on a collapsible gurney. The gurney is configured similar to a gurney that may be used to transport an injured person or patient in a hospital. The intent of the gurney is providing a mobile workbench that can be easily installed and removed from the back of a truck or vehicle by one person. One possible installation process is shown and described in FIG. 2. One embodiment of the mobile workbench as shown in FIG. 1, shows the mobile workbench 10 with a tool box 20 installed on top of the mobile workbench. In this embodiment, the workbench includes a tool chest 20 integrated into the mobile workbench. In the preferred embodiment, the toolbox is constructed from folded sheet metal, but it may also be constructed from wood, plastics or a combination thereof. The top surface of the toolbox may also be constructed of a different of wood or a different material than the toolbox is constructed. It is further contemplated that the workbench may be configured with different heights to accommodate a variety of different operations. It is further contemplated that the toolbox may be configured with different volume capacity compartments to accommodate a variety of different size tools. An expandable shelf or hinged section of the workbench may also exist to provide a larger work area. Holes or other features may be placed onto or through the surface of the workbench, drawers or sides of the toolbox to hold other items.

The toolbox rests upon a wheeled gurney type carriage that provides support for the toolbox and workstation and also allows easy movement and transportation of the mobile toolbox and work surface. In the preferred embodiment legs and structural supports similar to 50, 52, 54 and 100 support the toolbox and workstation. In this embodiment the legs are constructed of tubular steel, but the legs can be constructed for other materials that provide the structural support necessary. The bottom of the frame has three or more wheel, and in the preferred embodiment the bottom of the frame is supported on four wheels 40 as shown in the figure. A breaking mechanism 45 may exist on one or more wheels. An additional wheel or set of wheels 30 extend from under the bottom 70 of the toolbox/workbench. This wheel is positioned for placement in the back of a vehicle of the bed of a truck to allow the entire mobile tool box and work bench to be collapsed and placed within the back of the truck or vehicle by a single person. This is best shown and described in FIG. 2.

FIG. 2 is an isometric view of the collapsible gurney from FIG. 1 being loaded into the bed of a truck. From this figure, the collapsible gurney 10 is shown being placed into the back of a pick-up truck 60. This figure shows the height of the mobile workbench is constructed at about the same height as the bed of the truck. The wheel 30 located under the workbench is shown resting on the bed 65 of the truck 60. The height of the wheel 30 and the bed of the truck 65 make it ideal for placement within the bed of the truck with one person. As the gurney is pushed further into the bed of the truck, one or more of the legs 110 of the support structure of the gurney makes contact with the edge 65 of the bed of the truck and the carriage part of the gurney folds up under the tool box and work bench. This allows all the wheels 40 to be at the same height and the entire mobile tool station and workbench can be rolled into the vehicle. One or more wheels of the mobile too station can be locked 45 to prevent movement or rolling of the mobile workstation in the back of the vehicle.

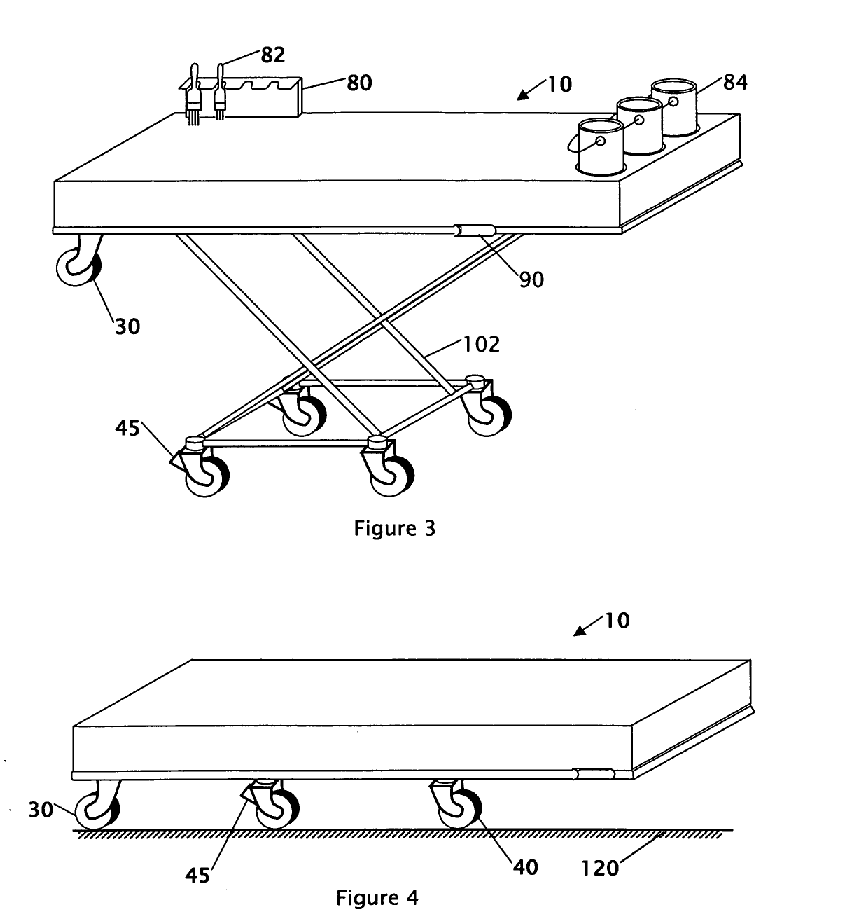

FIG. 3 is an isometric view of one embodiment of the mobile workbench 10 configured for painting with a height adjustable gurney. The top of the workbench in this embodiment is configured with locations for paint cans 84 and/or a holder for paint brushes 80. The paintbrushes 82 in the holder can be maintained in a vertical orientation. In this embodiment of the mobile tool station, wheels 30 are located under the mobile tool station to allow easy placement of the mobile workstation in the back of a truck or other vehicle. A height adjustment mechanism 90 allows the working surface of the mobile work station to be adjusted up or down to accommodate the user, or to collapse the mobile work station for placement in a truck or other vehicle. The height adjustment may be by means such as detents, screwed or stops to allow all incremental or infinite height positions. The cross member legs 102 can slide along the underside of the toolbox to accommodate the height adjustment. This configuration also includes one or more locking wheels 45.

FIG. 4 is an isometric view of the mobile workbench 10 from FIG. 3 shown in a collapsible configuration. This figure shows wheels 30 at the same horizontal orientation as the wheels 40 that support the mobile workstation when the mobile workstation is in the extended orientation. The wheels are shown at the same height on a flat surface 120 that can be the ground or the back of a truck. This configuration also includes one or more locking wheels 45.

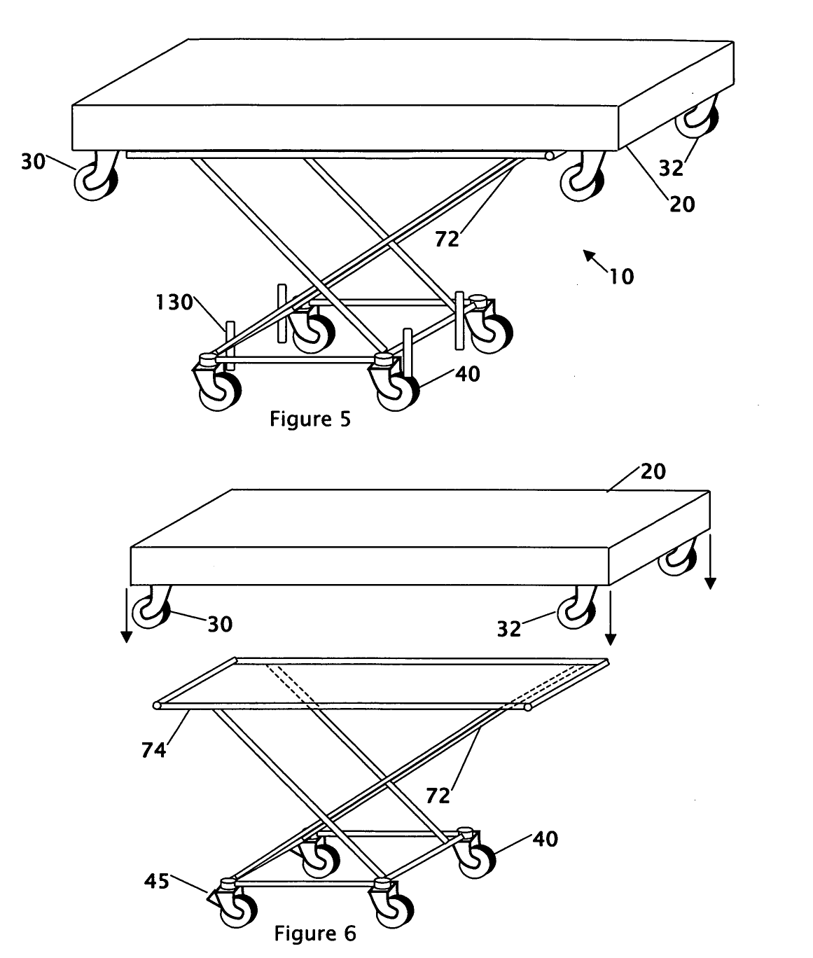

FIGS. 5 and 6 are isometric views of one embodiment of the mobile workbench 10 shown with a removable toolbox. In FIG. 5 the tool box 20 is shown resting on top of the mobile portion of the gurney 72. In FIG. 6 the tool box 20 is shown removed from the gurney 72. The working surface 74 is shown in FIG. 6 with the toolbox removed. Wheels 30 and 32 are shown attached to the underside of the toolbox so the toolbox can also be easily transported in the back of a truck separate from the gurney. The gurney has wheels 40 with break(s) 45 to hold the gurney or mobile workbench is position. An alternate method of preventing movement of one or more wheel is shown in FIG. 5 with standoffs 130 that can be raised or lowered to lift the wheels off the ground. This can also be used to adjust the height of the worktable.

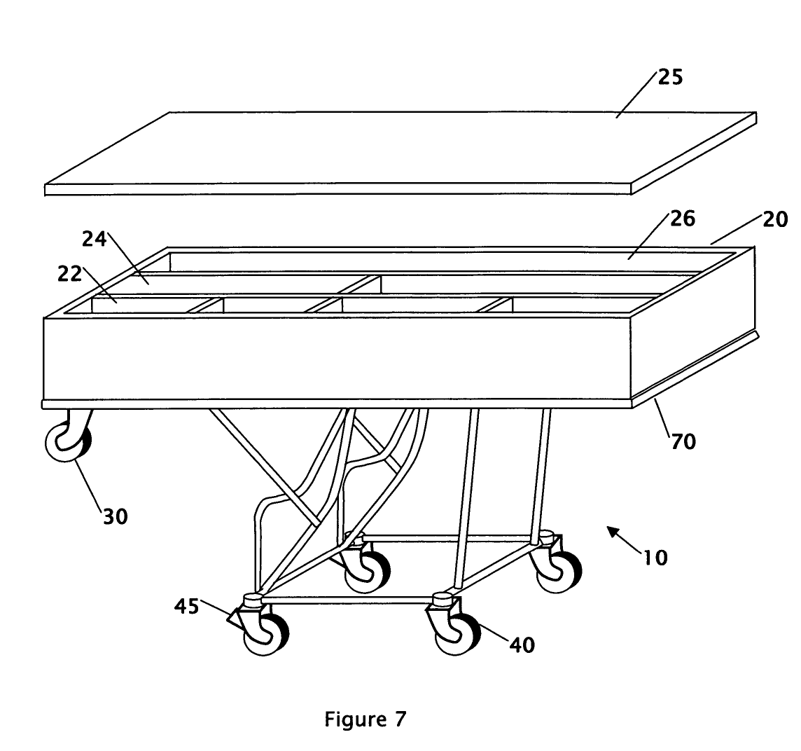

FIG. 7 shows an isometric view of one embodiment of the mobile workbench 10 shown with the worktop removed showing the internal compartments. The worktop 25 can be lifted off the top of the tool storage area to allow access to the tools or equipment stored inside the workbench, or the top may be hinged to the tool storage area. It is further contemplated that the hinged lid may be hinged with removable hinge pins to allow for both hinged access as well as removal of the workbench. The toolbox area 20 is constructed with a number of compartments of different sizes 22, 24, 26. For example a shovel may be placed in compartment 26 while smaller items such as stakes or a hammer may be placed in smaller compartments 22. While the storage area is shown with different size compartments, the compartments may all be the same size, or may be custom configured to accept specific tools in each compartment. Wheels 30, 40 and wheel breaking mechanism 45 are shown in this figure and described previously.

Thus specific embodiments and applications for a mobile tool bench have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A mobile tool station and work bench comprising:
an essentially flat work surface supported on a gurney type carriage that is further supported on at least three wheels, and further includes support means for at least temporal support of a tool case,
a locking mechanism for the at least one wheel to prevent the wheel from turning,
at least one wheel located on the underside of the essentially flat work surface, and
a height adjustment mechanism that allows the overall height of the gurney type carriage to be adjusted.

2. The mobile tool station and workbench according to claim 1 wherein the essentially flat work station is constructed from a group consisting of wood, metal, lattice, and plastic.

3. The mobile tool station and workbench according to claim 1 wherein the at least three wheels is selected from a group consisting of metal, rubber, plastic or a combination thereof.

4. The mobile tool station and workbench according to claim 1 wherein the at least temporal support for the tool bench consists of guides, rails or a rack that allows the tool bench to be supported at least partially within or upon the mobile tool station/workbench, and further wherein the tool bench can be secured and or removed from the mobile tool station and workbench.

5. The mobile tool station and workbench according to claim 1 wherein the locking mechanism consists of a frictional brake, clamp brake, disk brake, or a feature that allows the wheel to be raised from contacting the ground.

6. The mobile tool station and workbench according to claim 1 wherein the at least one wheel located under the essentially flat work surface is positioned to fit on the bed of a vehicle.

7. The mobile tool station and workbench according to claim 1 wherein the height adjustment of the gurney type carriage can be reduced to a height less than the height of the at least one wheel located under the essentially flat work surface such that the wheel located under the essentially flat work station and the at least three wheels are coplanar.

8. A mobile tool station and work bench comprising:
an essentially flat work surface supported on a gurney type carriage that is further supported on at least three wheels,
a locking mechanism for the at least one wheel to prevent the wheel from turning,
a height adjustment mechanism that allows the overall height of the gurney type carriage to be adjusted to allow the height if the essentially flat work surface to be adjustable up or down to accommodate a user.

9. The mobile tool station and workbench according to claim 8 wherein the essentially flat work station is constructed from a group consisting of wood, metal, lattice, and plastic.

10. The mobile tool station and workbench according to claim 8 wherein the at least three wheels is selected from a group consisting of metal, rubber, plastic or a combination thereof.

11. The mobile tool station and workbench according to claim 8 wherein the at least temporal support for the tool bench consists of guides, rails or a rack that allows the tool bench to be supported at least partially within or upon the mobile tool station/workbench, and further wherein the tool bench can be secured and or removed from the mobile tool station and workbench.

12. The mobile tool station and workbench according to claim 8 that further includes at least one wheel located on the underside of the essentially flat work surface.

13. The mobile tool station and workbench according to claim 8 wherein the locking mechanism consists of a frictional brake, clamp brake, disk brake, or a feature that allows the wheel to be disengaged from contacting the ground.

14. A mobile tool station and workbench comprising:
an essentially flat work surface that is removably supported on a gurney type carriage that is further supported on at least three wheels,
wherein the essentially flat work surface and the gurney type carrier can be separated from each other.

15. The mobile tool station and workbench according to claim 14 wherein the essentially flat work station is constructed from a group consisting of wood, metal, lattice, and plastic.

16. The mobile tool station and workbench according to claim 14 wherein the at least three wheels is selected from a group consisting of metal, rubber, plastic or a combination thereof.

17. The mobile tool station and workbench according to claim 14 wherein the at least temporal support for the tool bench consists of guides, rails or a rack that allows the tool bench to be supported at least partially within or upon the mobile tool station/workbench, and further wherein the tool bench can be secured and or removed from the mobile tool station and workbench.

18. The mobile tool station and workbench according to claim 14 further includes a wheel locking mechanism consisting of a frictional brake, clamp brake, disk brake, or a feature that allows the wheel to be disengaged from contacting the ground.

19. The mobile tool station and workbench according to claim 14 that further includes at least one wheel located under the essentially flat work surface positioned to fit on the bed of a vehicle.

20. The mobile tool station and workbench according to claim 14 that further includes a height adjustment mechanism on the gurney type carriage where the overall height of the mobile tool station and workbench can be reduced.
